(19) United States
(12) Patent Application Publication
(10) Pub. No.: US 2005/0175841 A1
(43) Pub. Date: Aug. 11, 2005

(54) Electroluminescent panel

(75) Inventors: Rifat Ata Mustafa Hikmet, Eindhoven (NL); Henricus Albertus Maria Van Hal, Eindhoven (NL); Eliav Itzhak Haskal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/513,747

(22) PCT Filed: Apr. 17, 2003
(86) PCT No.: PCT/IB03/01543

(30) Foreign Application Priority Data
May 10, 2002 (EP) 02076852.9

(51) Int. Cl. B32B 19/00

(52) U.S. Cl. 428/411.1; 428/698; 428/702

(57) ABSTRACT

A laminated electroluminescent panel comprising: a supporting transparent substrate; an organic device formed on the transparent substrate defining a plurality of pixels; the organic device including an organic luminescent layer between a lower and an upper electrode layer, and a sealing layer positioned to form together with the substrate a hermetic, moisture proof encapsulation for the organic device. The sealing layer comprises an inorganic material, and a hydrogen gutter is located inside the encapsulation at a position in physical connection with the organic luminescent layer. The hydrogen gutter prevents the building-up of pressure inside the encapsulation due to hydrogen gas formed due to and during operation of the organic device.

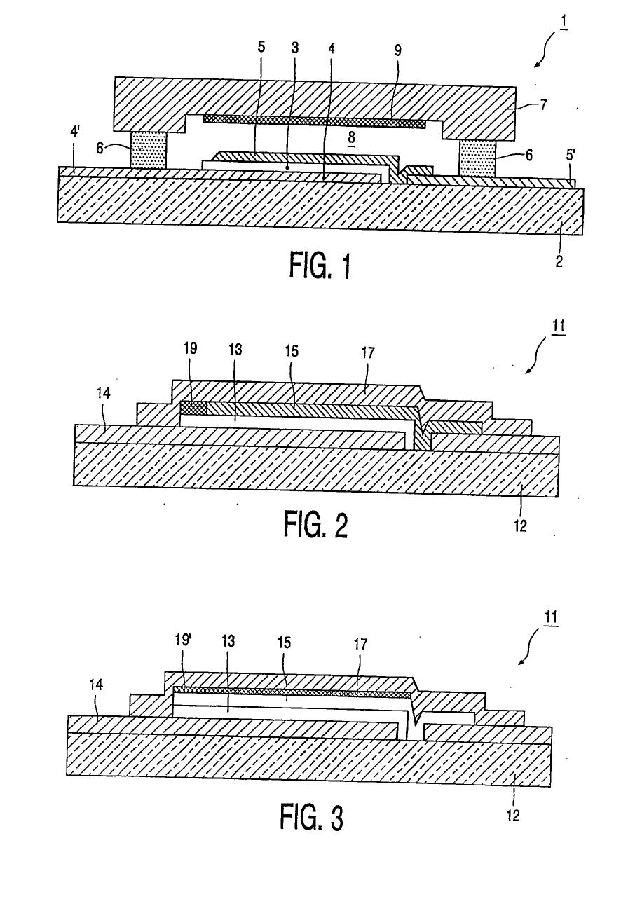

The present invention relates to an electroluminescent panel comprising an organic luminescent device protected against the penetration of oxygen and moisture. U.S. Pat. No. 5,124,204 describes (in conjunction with FIG. 1) a conventional organic electroluminescent device which is prepared by forming on a glass base plate (2) a lower transparent electrode (4), an organic electroluminescent layer (3), and an upper electrode (5) in this order. In order to prevent moisture from reaching the EL element, it is covered by a sealing plate (7) which is adhered to the glass base plate (2) by an adhesive (6), such as an epoxy resin. Underneath the sealing plate (7) moisture absorbing material (9) is placed.

In order to obtain a highly reliable organic electroluminescent device, a large quantity of moisture absorbing material should be present in order to be able to absorb moisture during the whole lifetime of the organic electroluminescent device. This is due to the fact that the device is not hermetically sealed but the epoxy glue is permeable to moisture and also to gases such as oxygen, hydrogen, nitrogen and helium. The large quantity of moisture absorbing material means an increase in the total device thickness. It is for that reason that there is a search for (laminated) hermetically sealed devices. Such a device can be hermetically sealed by deposition of an inorganic layer over the organic device and the substrate. If the layer material is a metal, additional electrically insulating, unpermeable, layers may have to be added to prevent short-circuiting.

However a problem with this approach appears to be the production of hydrogen gas during the operation of the panel. The gas is produced mainly by the electrolysis of water remaining in the electroluminescent polymer. Some crosslinking reactions within the polymer can also lead to the formation of hydrogen gas within the system. As a result of gas production volume expansion and bursting and/or delamination can take place.

It is, inter alia, an object of the invention to provide an improved hermetically sealed, organic, electroluminescent panel.

According to the invention, an electroluminescent panel of the type described in the preamble is characterized in that the sealing layer comprises an inorganic material and in that a hydrogen getter is located inside the encapsulation at a position in physical connection with the organic luminescent layer. By the expression in physical connection is meant in contact or in indirect contact Direct contact is the case e.g. of the getter is arranged on the periphery of the luminescent layer. Indirect contact means that the getter is separated from the organic device by a gas permeable layer. This can be e.g. the upper electrode layer, provided that it has pinholes through which gas can pass.

By its physical connection with the organic luminescent layer wherein hydrogen can be produced during operation, the hydrogen getter can bind, absorb or trap produced hydrogen. Bursting and/or delamination can be effectively prevented in this way.

A preferred embodiment is characterized in that a layer which is permeable for hydrogen is arranged on the upper electrode layer, the hydrogen getter being arranged on the hydrogen permeable layer and being in physical connection with the organic luminescent layer through the hydrogen permeable layer and pinholes in the upper electrode layer.

In this manner accumulation of the reactions whereby hydrogen is produced can be prevented by spreading the hydrogen over a larger surface (the surface of the upper electrode).

According to a further embodiment the hydrogen permeable layer comprises an inorganic oxide or nitride and/or palladium.

EP 777 280 discloses a laminated construction in which the organic device stack is covered with an organic buffer layer which is overcoated with a layer of a low work function metal which acts as a thermal coefficient matching layer and as a gettering material. However, in such a construction the particular arrangement of the organic buffer layer makes that the getter material is not in physical connection with the organic polymer layer of the organic device and therefor cannot act to trap hydrogen produced by the organic polymer layer. In the known construction the getter material can only absorb moisture and the like at the outside of the buffer layer.

In the framework of the invention suitable materials for use as hydrogen traps are materials or material combinations (alloys or intermetallic compounds) selected from the group consisting of:
a) alkaline metals
b) alkaline earth metals
c) lanthanides
d) Sc, Y
e) Pd, Rh, Ni, Zr

Very effective hydrogen traps are formed by an alloy of at least one (earth) alkali metal with Aluminum (in particular Ba₄Al is a good candidate), and by intercalation materials of at least one (earth) alkali metal intercalated in C, Si, Ge, Sn or Pb. In particular the intercalation of Li into C gives good results.

Further a molecular sieve powder, e.g. Al₂O₃, based powder with pores of a (small) size in which hydrogen can be trapped can be advantageously be used. An example is Sodium-Alumino-Silicate (0.6 K₂O: 4 Na₂O: Al₂O₃: 2 SiO₂).

Of the above group e) Zr Pd compounds appear to be good representatives, in particular Zr₉Pd₁.

The getter material layers can be advantageously be deposited by evaporation or sputtering.

These and other objects and features of the present invention will become clearer from the following description taken in conjunction with preferred embodiments thereof with reference to the accompanying drawings, in which:

FIG. 1 is a schematic sectional view of a prior art electroluminescent panel;

FIG. 2 is a schematic sectional view of a first embodiment of this invention;

FIGS. 3-5 are schematic sectional views of further embodiments of this invention.

FIG. 1 shows an electroluminescent (EL) display device 1, comprising a glass substrate 2 on which several layers have been deposited by means of processes which are generally know in the art, such as physical or chemical vapor deposition, or ink-jet printing. The device 1 comprises an active or emissive layer 3 comprising an organic electroluminescent material, such as a coumarin (organic LED), or a conjugated polymer like PPV (poly(P-phenylene vinylene)) or a PPV-derivative (polymer LED), sandwiched between two patterns of electrode layers of an electrically conductive material. In this example, the electrode layers comprise first electrodes 4, which are deposited directly onto the glass substrate 2, and second electrodes 5, whereby a matrix of light emitting diodes (LED's) is formed. At least electrode 4 is made of a material, such as Indium Tin Oxide (ITO, that is transparent to the light emitted by the active layer 3. During operation, the first electrodes 4 are driven such that they are at a sufficient high positive voltage relative to the row electrodes 5, to inject holes in the active layer 3. The emissive layer 3 may comprise one, or a plurality of organic layers. For simplicity's sake in the following the expression “the organic layer” will be used irrespective of the fact whether there is one or a plurality of organic layers.

The stack of layers 3, 4 and 5 is contained in a cavity 8 which is formed by a cover 7, which is secured to the glass substrate 2 by an adhesive 6, such as a thermosetting two-component epoxy resin. The sealed container formed by the glass substrate 2 and the cover 7 sealed onto the substrate 2 using the adhesive 6, is on the inside provided with a moisture absorption means 9 such that the moisture absorbing material is spaced from the stack of layers 3, 4 and 5. For example, the moisture absorption means 9 may be attached to the cover 7 as depicted in FIG. 1.

A disadvantage of the FIG. 1 prior art construction is that it cannot be made thin enough for certain applications, like hand held telephones.

The invention aims at an extremely thin electroluminescent panel, which is realized by forming the organic device and the protective cover as a layer stack. In a such compact construction, in which adjacent layers are in physical contact, there is no (permeable) adhesive seam and no moisture getter (trap).

FIG. 2 shows a cross-section of an example of an electroluminescent panel of the layer stack (or: laminated) type. A substrate 12, which may be a glass substrate or e.g. a plastic substrate which has been made impermeable for moisture and gasses carries a lower electrode layer 14, an organic (polymer) electroluminescent material layer 13 and an upper electrode layer 15, which together form the organic device. The layer stack 13, 14, 15 is completed by a seating layer 17 of inorganic material, e.g. a carbide or a nitride, in particular silicon nitride, or an electrically insulating, moisture impermeable, metal oxide, which covers the organic device. Together with substrate 12, sealing layer 17 “encapsulates” the organic device. The resulting EL panel 11 can be very thin.

However a problem with this approach is the production of hydrogen gas during the operation of the panel. The gas is produced mainly by the electrolysis of water remaining in the electroluminescent polymer. Some crosslinking reactions within the polymer can also lead to the formation of hydrogen gas within the system. As a result of gas production volume expansion and bursting and/or delamination of the stack can take place. Due to the hermetic encapsulation the gas cannot escape.

In order to solve this problem a hydrogen trap 19 is arranged inside the layer stack 13, 14, 15, 17, at a position in physical connection with the organic (polymer) layer 13. In the FIG. 2 embodiment the hydrogen trap 19 is arranged in physical contact with the periphery of the organic (polymer) layer 13. Assuming that layer 13 has four sides, the hydrogen trap 19 can be arranged in physical contact with the periphery along one side, or a plurality of sides of layer 13.

Suitable materials for the hydrogen trap 18 are
a) alkaline metals
b) alkaline earth metals
c) lanthanides
d) Sc, Y
e) Pd, Rh, Ni, Zr
   and their combinations (alloys and intermetallic compounds)

Further suitable materials are materials from the above groups, in particular a) and b), in combination with Al (in particular Ba₄Al) and intercalation materials of the materials from the above groups, in particular a) and b), intercalated into C, Si, Ge, Sn, Pb (in particular Li intercalated into C).

Molecular sieve powders with pores of a size that H can be trapped can also be used (e.g. Al₂O₃) based powders, like (0.6 K₂O: 4Na₂O₃: Al₂O₃: 2 SiO₂).

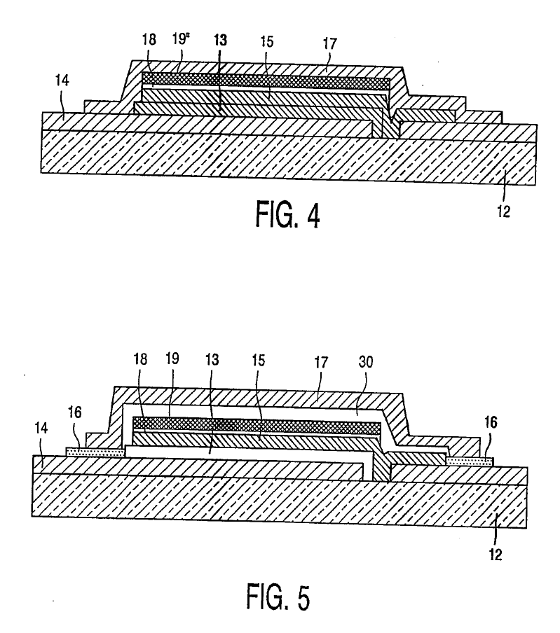

FIG. 3, in which for the same elements the same reference numerals are used as in FIG. 2, shows another alternative for the FIG. 2 construction A hydrogen trap 19 is formed on the upper surface of top electrode 15. Hydrogen gas produced in organic layer 13 can reach the hydrogen trap 19′ through pinholes in electrode 15. In this embodiment the hydrogen getter 19′ is not in direct physical contact, but in physical connection (through pinholes in electrode 15) with organic layer 13. A disadvantage of this embodiment is that if (a substantial amount of) hydrogen gas is produced at a single place of the organic layer 13 it will accumulate at a single place in the hydrogen trap 19′. This is undesired. FIG. 4 presents an embodiment in which this problem is solved.

FIG. 4, in which for the same elements the same reference numerals are used as in FIG. 2, shows another alternative for the FIG. 2 construction. A hydrogen permeable layer 18 is arranged in a position where it is in physical contact with polymer layer 13 and in physical contact with hydrogen getter 19″. In this manner hydrogen getter 19″ is in physical connection with polymer layer 13 and accumulation of produced hydrogen at a single place is prevented by spreading hydrogen over a larger surface via the hydrogen permeable layer 18.

Layer 18 can be of any material which is permeable to hydrogen gas. A very special example for layer 8 is a layer of palladium which is permeable to hydrogen but not to other gases. Other examples of such layer (it can also be combined with palladium) are inorganic oxides, nitrides, etc. (e.g. silicon oxide, aluminum oxide, silicon nitride). Usually during the sputtering or evaporation of these materials layers which are permeable to gases are obtained. Layer 18 can also be an organic material with a high glass transition temperature. In the same way layer 30 can also be chosen amongst electrically insulating organic or inorganic materials.

In order to be able to produce a defect free inorganic sealing layer 17, it is advantageous to first deposit over the organic device layer stack 13, 14, 15 a planarization layer. Hydrogen getter layer 19′, 19″ can advantageously act as such a planarization layer.

As a material for the inorganic sealing layer 17 a nitride, an oxynitride, a metal-oxide or a metal can be used. It has been found that e.g. a defect free layer of Al can be vacuum deposited to a thickness in the range of 500-5000 å in order to produce a hermetic seal.

The use of a metal sealing layer 21 is shown in FIG. 5, in which for the same elements the same reference numerals are used as in FIG. 3.

In this case an electrical isolation means 16 is arranged between the (metal) sealing layer 21 and the lower electrode layer 14 in order to prevent short circuiting. For the same purpose a layer 30 of electrically insulating material is deposited at least over the exposed portion of upper electrode 15 before inorganic sealing layer 17 is deposited. The electrical isolation materials used can be an inorganic material, e.g. a low melting glass or a ceramic material, or an organic material. Analogously, if the getter 19 (FIG. 2), 19′ (FIG. 3) or 19″ (FIG. 4) is of electrically conductive material, and an electrically conductive material, like e.g. Al, is selected for the sealing layer 17, the arrangement of electrically insulating layers like layers 30 and 16 in FIG. 5 may be necessary to prevent short circuiting.

Summarizing, the invention relates to a laminated electroluminescent panel comprising:
a supporting transparent substrate;
an organic device formed on the transparent substrate defining a plurality of pixels; the organic device including an organic luminescent layer between a lower and an upper electrode layer; and
a sealing layer positioned to form together with the substrate a hermetic, moisture proof encapsulation for the organic device. The sealing layer comprises an inorganic material and a hydrogen getter is located inside the encapsulation at a position in physical connection with the organic device. The hydrogen getter prevents the building-up of pressure inside the encapsulation due to hydrogen gas formed due to and during operation of the organic device.

1. Electroluminescent panel comprising:
a supporting transparent substrate;
an organic device formed on the transparent substrate defining a plurality of pixels; the organic device including an organic luminescent layer between a lower and an upper electrode layer; and
a sealing layer positioned to form together with the substrate an encapsulation for the organic device, characterized in that the sealing layer comprises an inorganic material and in that a hydrogen getter is located inside the encapsulation at a position in physical connection with the organic luminescent layer.

2. A panel as claimed in claim 1, characterized in that the hydrogen getter is in physical contact with the periphery of the organic luminescent layer.

3. A panel as claimed in claim 1, characterized in that the hydrogen getter is arranged directly on the upper electrode layer and is in physical connection with the organic luminescent layer through pinholes in the upper electrode layer.

4. A panel as claimed in claim 1, characterized in that a hydrogen permeable layer is arranged on the upper electrode layer, the hydrogen getter being arranged on the hydrogen permeable layer and being in physical connection with the organic luminescent layer through the hydrogen permeable layer and pinholes in the upper electrode layer.

5. A panel as claimed in claim 3, characterized in that the hydrogen permeable layer comprises an inorganic oxide or nitride and/or Pd.

6. A panel as claimed in claim 1, characterized in that the hydrogen getter comprises a material or material combination selected form the group consisting of:
a) alkaline metals
b) alkaline earth metals
c) lanthanides
d) Sc, Y
e) Pd, Rh, Ni, Zr

7. A panel as claimed in claim 1, characterized in that the hydrogen getter comprises an intermetallic compound of at least one alkali metal, or at least one each alkali metal, with Al.

8. A panel as claimed in claim 1, characterized in that the hydrogen getter includes an intercalation material comprising at least one alkaline metal, or at least one alkaline earth metal, intercalated in C, Si, Ge, Sn or Pb.

9. A panel as claimed in claim 1, characterized in that the hydrogen getter comprises a molecular sieve powder, the powder particles having cavities of a size in which hydrogen can be trapped.

10. A panel as claimed in claim 1, characterized in that the inorganic sealing layer is a metal, metal-oxide, carbide, or nitride layer.
